(19) United States
(12) Patent Application Publication
(10) Pub. No.: US 2025/0307092 A1
(43) Pub. Date: Oct. 2, 2025

(54) STORAGE SYSTEM AND METHOD FOR CONTROLLING STORAGE SYSTEM

(71) Applicant: Hitachi Vantara, Ltd., Yokohama-shi (JP)

(72) Inventor: Junichi IIDA, Tokyo (JP)

(73) Assignee: Hitachi Vantara, Ltd., Yokohama-shi (JP)

(21) Appl. No.: 18/825,220

(22) Filed: Sep. 5, 2024

(30) Foreign Application Priority Data
Mar. 27, 2024 (JP) 2024-051584

(51) Int. Cl. G06F 11/20; G06F 11/07

(52) U.S. Cl. CPC G06F 11/2089; G06F 11/0772; G06F 11/2094

(57) ABSTRACT

A controller of a storage system according to one aspect of the invention includes a failure sign monitoring unit configured to acquire information on a state of a DIMM, and monitor and detect a sign of an irreparable failure in the DIMM based on the acquired information, and a control unit configured to copy or move cache data in which redundancy is lost to a specified saving destination when the failure sign monitoring unit detects the sign of the failure.

### BACKGROUND OF THE INVENTION

### 1. Field of the Invention

The present invention relates to a storage system and a method for controlling a storage system.

### 2. Description of Related Art

In the related art, a storage system has been known in which data redundancy is achieved by using a plurality of drives including magnetic disk devices and the like. In such a storage system, a controller board (hereinafter, also simply referred to as a “controller”) on which a main memory, a cache memory, and the like are mounted is made redundant, and cache data before being saved to the drive are also made redundant. However, in the storage system configured in this way, for example, when one controller having a redundant configuration becomes an inoperable state, the redundancy of the cache data is not maintained.

PTL 1 discloses a disk array subsystem in which two memory controllers included in each of two clusters having redundant configurations independently determine an address for storing cache data independently and without relation to the other. Since the disk array subsystem has such a configuration, data transferred from a host controller is stored in pages at different addresses in the two memory controllers. That is, directories managed by the two memory controllers have different contents.

According to the disk array subsystem disclosed in PTL 1, there is no need to match management contents in respective directories between the two memory controllers in the cluster at the time of data recovery. Therefore, in the disk array subsystem disclosed in PTL 1, dirty data stored in the other memory controller, that is, data unwritten to the disk is written to any storage address of the cache memory in the failed memory controller, and accordingly the redundancy of the data in the cluster can be recovered.

### CITATION LIST

### Patent Literature

PTL 1: JP2010-92318A

### SUMMARY OF THE INVENTION

Incidentally, a memory module including both a cache memory and a main memory may be adopted as a memory module mounted on the controller. In such a memory module, for example, a failure such as a correctable error occurs continuously within a short period of time and when the number of occurrences exceeds a threshold error number, the controller is blocked. Then, in a state in which one controller is blocked, that is, in a state in which the redundancy of cache data is lost, the cache data is lost when a failure occurs also in the other controller having the redundant configuration. That is, data loss occurs.

The invention has been made in view of the above situations. An object of the invention is to enable data loss avoidance processing before data loss of the cache data occurs.

A storage system according to one aspect of the invention is a storage system including: a plurality of controllers each including a cache memory and having a redundant configuration; and a drive configured to allow cache data of the cache memory to be stored therein. The controller of the storage system according to one aspect of the invention includes a failure sign monitoring unit configured to acquire information on a state of the cache memory, and monitor and detect a sign of an irreparable failure in the cache memory based on the acquired information, and a control unit configured to copy or move cache data in which redundancy is lost to a predetermined saving destination when the failure sign monitoring unit detects the sign of the failure.

According to at least one aspect of the invention, it is possible to perform data loss avoidance processing before the data loss in a memory module occurs.

Problems, configurations, and effects other than those described above will be clarified by the following description of an embodiment.

### BRIEF DESCRIPTION OF THE DRAWINGS

FIG. 1 is a diagram showing a configuration example of a controller on which a plurality of memory modules are mounted in the related art;

FIG. 2 is a diagram showing an example of a state transition of a DIMM in the related art;

FIG. 3 is a flowchart showing an example of a procedure of an error status monitoring processing on the DIMM by a CPU in the related art;

FIG. 4 is a diagram showing a configuration example of a storage system having a redundant configuration in the related art;

FIG. 5 is a diagram showing an example of a state transition of redundancy of the controller in the related art;

FIG. 6 is a block diagram showing a configuration example of a storage system according to an embodiment of the invention;

FIG. 7 is a diagram showing an example of storage information of a DIMM according to the embodiment of the invention;

FIG. 8 is a diagram showing a configuration example of a management table according to the embodiment of the invention;

FIG. 9 is a diagram showing a configuration example of a directory table according to the embodiment of the invention;

FIG. 10 is a flowchart showing an example of a procedure of control processing of the storage system according to the embodiment of the invention;

FIG. 11 is a flowchart showing an example of a procedure of data loss avoidance processing when the speed of data loss avoidance is emphasized according to the embodiment of the invention;

FIG. 12 is a flowchart showing an example of a procedure of the data loss avoidance processing when reliability (certainty) of the data loss avoidance is emphasized according to the embodiment of the invention;

FIG. 13 is a flowchart showing an example of a procedure of first redundancy recovery processing according to the embodiment of the invention;

FIG. 14 is a flowchart showing an example of a procedure of second redundancy recovery processing according to the embodiment of the invention; and

FIG. 15 is a flowchart showing an example of a procedure of third redundancy recovery processing according to the embodiment of the invention.

### DESCRIPTION OF EMBODIMENTS

Hereinafter, an embodiment of the invention will be described with reference to the drawings. In the drawings, the same configurations are denoted by the same reference numerals. The following description and drawings are examples for describing the invention and are appropriately omitted and simplified for clarity of the description. The invention can be implemented in various other forms. Unless otherwise specified, each component may be single or plural.

### Problems to be Solved by Invention

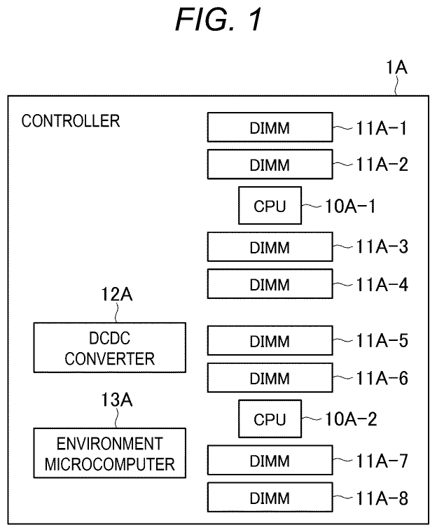

Before going into the description of the embodiment of the invention, first, problems to be solved by the invention will be described with reference to FIGS. 1 to 5.

FIG. 1 is a diagram showing a configuration example of a controller on which a plurality of memory modules are mounted in the related art. A controller 1A shown in FIG. 1 includes a central processing unit (CPU) 10A-1 and a CPU 10A-2. The controller 1A includes a dual inline memory module (DIMM) 11A-1 to a DIMM 11A-8 as memory modules. The DIMM 11A-1 to DIMM 11A-8 function as a cache memory and also serve as a main memory. The DIMM 11A-1 to DIMM 11A-4 are controlled by the CPU 10A-1, and the DIMM 11A-5 to DIMM 11A-8 are controlled by the CPU 10A-2.

Each of the DIMM 11A-1 to DIMM 11A-8 includes a temperature sensor (not shown). The DIMM 11A-1 to DIMM 11A-4 output temperature information measured by the temperature sensors to the CPU 10A-1, and the DIMM 11A-5 to DIMM 11A-8 output temperature information measured by the temperature sensors to the CPU 10A-2.

The DIMM 11A-1 to DIMM 11A-4 output the number of DIMM errors (hereinafter also simply referred to as errors) that occur to the CPU 10A-1. The DIMM errors include a correctable error and the like that can be corrected by the CPU. The DIMMs 11A-5 to 11A-8 output the number of DIMM errors that occur to the CPU 10A-2. In the following description, when there is no need to distinguish between the CPU 10A-1 and the CPU 10A-2, the CPU 10A-1 and the CPU 10A-2 are collectively referred to as a “CPU 10A”. When there is no need to distinguish between the DIMM 11A-1 to DIMM 11A-8, the DIMM 11A-1 to DIMM 11A-8 are collectively referred to as a “DIMM 11A”.

The number of errors that occur in the DIMM 11A is counted by an error counter (not shown) or the like until a timer (not shown) expires. That is, the error occurrence number which is output from the DIMM 11A to the CPU 10A is the number of errors that occur until the timer has expired. The timer is set to, for example, one day (24 hours). Alternatively, the error occurrence number is the error occurrence number at a time point at which the number of errors that occur exceeds a predetermined threshold error number.

The controller 1A further includes a DCDC converter 12A and an environment micro controller unit (MCU) 13A. The DCDC converter 12A converts a DC voltage supplied from a power source (not shown) into a DC voltage suitable for each of the CPUs 10A-1 and 10A-2 and the DIMM 11A-1 to DIMM 11A-8 and supplies the converted DC voltage to each of the CPU 10A-1, the CPU 10A-2, and the DIMM 11A-1 to DIMM 11A-8.

The environment MCU 13A checks whether there is an abnormality in the temperature, voltage, or the like of the controller 1A. The environment MCU 13A acquires information on a magnitude of the DC voltage supplied from the DCDC converter 12A to each of the DIMM 11A-1 to DIMM 11A-8 and outputs the information to the CPU 10A-1 or the CPU 10A-2.

When the CPU 10A accesses the DIMM 11A and performs read, the CPU 10A performs a cyclic redundancy check (CRC) or a parity check of an error correcting code (ECC). When a DIMM error is detected, the CPU 10A corrects the error. The CPU 10A also performs control to block the controller 1A according to an error content and the number of occurrences.

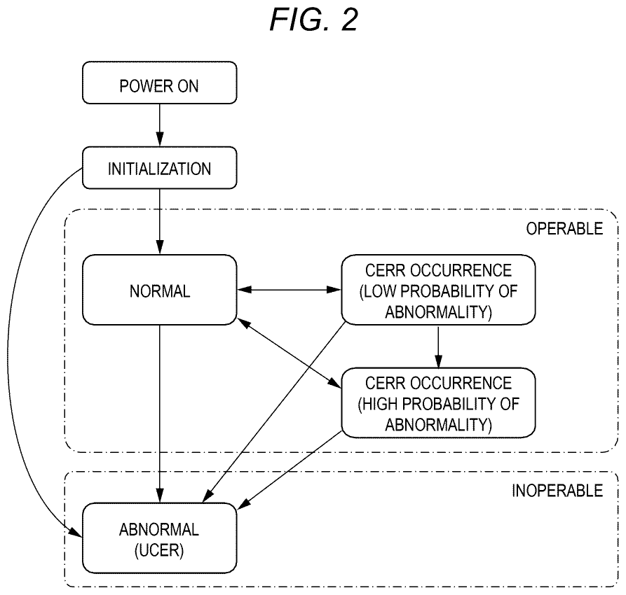

FIG. 2 is a diagram showing an example of a state transition of the DIMM 11A. First, when a power source of a device (not shown) on which the controller 1A is mounted is turned on, the DIMM 11A is initialized. At the stage of initialization, an uncorrectable error (expressed as “UCER” in the drawing) may occur. In this case, the DIMM 11A transitions to an abnormal state and becomes inoperable.

When the DIMM 11A starts operating normally, a correctable error with a low probability that the DIMM 11A is abnormal (expressed as “CERR” in the drawing) or a correctable error with a high probability that the DIMM 11A is abnormal occurs in the DIMM 11A. When the number of occurrences of these correctable errors exceeds a predetermined threshold error number, the DIMM 11A transitions to the abnormal state and becomes inoperable.

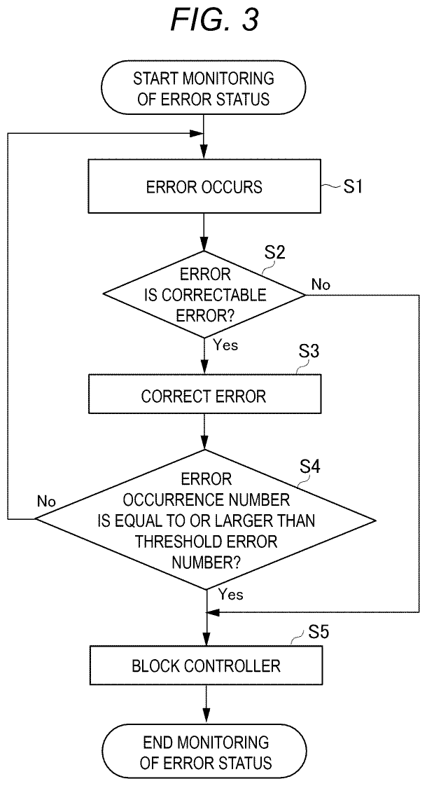

FIG. 3 is a flowchart showing an example of a procedure of an error status monitoring processing on the DIMM 11A by the CPU 10A.

First, the CPU 10A detects an error of the DIMM 11A (step S1). Next, the CPU 10A determines whether the error is a correctable error (step S2). If it is determined in step S2 that the error is a correctable error (YES in step S2), the CPU 10A corrects the error (step S3). Next, the CPU 10A determines whether the number of occurrences of the error is equal to or larger than the predetermined threshold error number (step S4). In step S4, when it is determined that the number of occurrences of the error is less than the threshold error number (NO in step S4), the CPU 10A returns the processing to step S1.

On the other hand, if it is determined in step S4 that the number of occurrences of the error is equal to or larger than the threshold error number (YES in step S4), or if the determination in step S2 is NO, that is, if the error is an un-correctable error that cannot be corrected, the CPU 10A blocks the controller 1A (step S5). After the processing of step S5, the error status monitoring processing on the DIMM 11A by the CPU 10A ends.

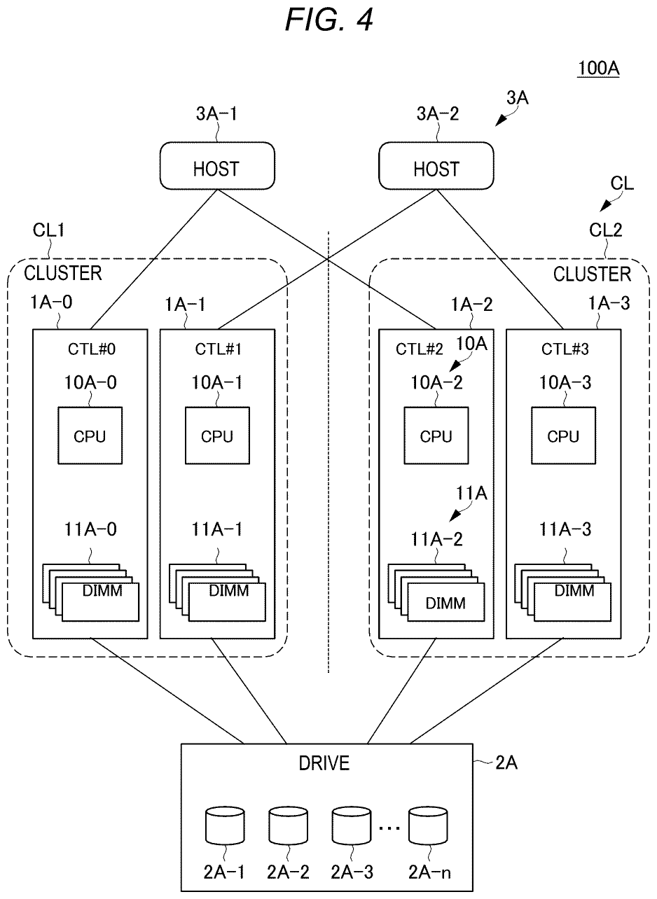

FIG. 4 is a diagram showing a configuration example of a storage system 100A having a redundant configuration in the related art. The storage system 100A includes a host 3A-1, a host 3A-2, a controller 1A-0 to a controller 1A-3, and a drive 2A. The host 3A-1 is connected to the controller 1A-0 and the controller 1A-2, and the host 3A-2 is connected to the controller 1A-1 and the controller 1A-3. The host 3A-1 instructs the controller 1A-0 and the controller 1A-2 to read and write data, and the host 3A-2 instructs the controller 1A-1 and the controller 1A-3 to read and write data. Configurations of the controller 1A-0 to controller 1A-3 are the same as that of the controller 1A shown in FIG. 1.

The controller 1A-0 and the controller 1A-1 implement a cluster CL1, and the controller 1A-2 and the controller 1A-3 implement a cluster CL2. That is, in the cluster CL1, redundancy is achieved by the controller 1A-0 and the controller 1A-1, and redundancy is achieved by the controller 1A-2 and the controller 1A-3 in the cluster CL2. The cluster CL1 and the cluster CL2 are connected to different power sources (not shown), and the cluster CL1 and cluster CL2 are also made redundant.

When both the controller 1A-0 and the controller 1A-1 operate normally in the cluster CL1, redundancy of the controller is maintained. In contrast, when one controller of the controller 1A-0 and controller 1A-1 is not operating in the cluster CL1, the redundancy of the controller is not maintained. Similarly, when both the controller 1A-2 and the controller 1A-3 operate normally in the cluster CL2, the redundancy of the controller is maintained. In contrast, when one controller of the controller 1A-2 and the controller 1A-3 is not operating in the cluster CL2, the redundancy of the controller is not maintained.

The controller 1A-0 to controller 1A-3 are connected to the drive 2A. The drive 2A includes a plurality of drive 2A-1 to drive 2A-n (n is a natural number equal to or larger than 2).

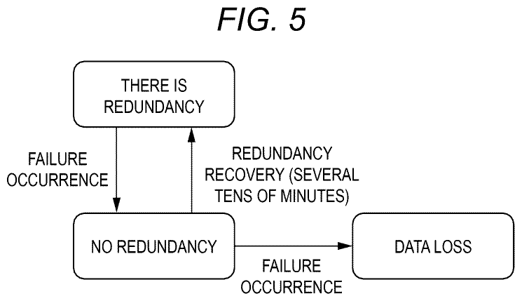

FIG. 5 is a diagram showing an example of a state transition of redundancy of a controller in the related art. It is assumed that, in each of the cluster CL1 and the cluster CL2, in a state in which redundancy of the controller is present (maintained), a failure occurs in the DIMM 11A of any controller 1A, and the controller 1A becomes inoperable. In this case, the cluster transitions to a state in which there is no redundancy of the controller. In a state in which there is no redundancy of the controller, redundancy recovery processing is performed by the CPU 10A. The redundancy recovery processing usually requires several tens of minutes.

It is assumed that the other controller becomes inoperable during the execution of the redundancy recovery processing. In this case, dirty data held in each of the two controllers, that is, the data not stored in the drive 2A is lost. That is, data loss occurs. For example, when a correctable error occurs accidentally and continuously in time in each of different controllers, both of the two controllers become inoperable, resulting in data loss. A storage system according to the invention monitors a sign that an unrecoverable failure occurs which leads to a blockage of a controller, and performs data loss avoidance processing when the sign is detected.

### Configuration of Storage System

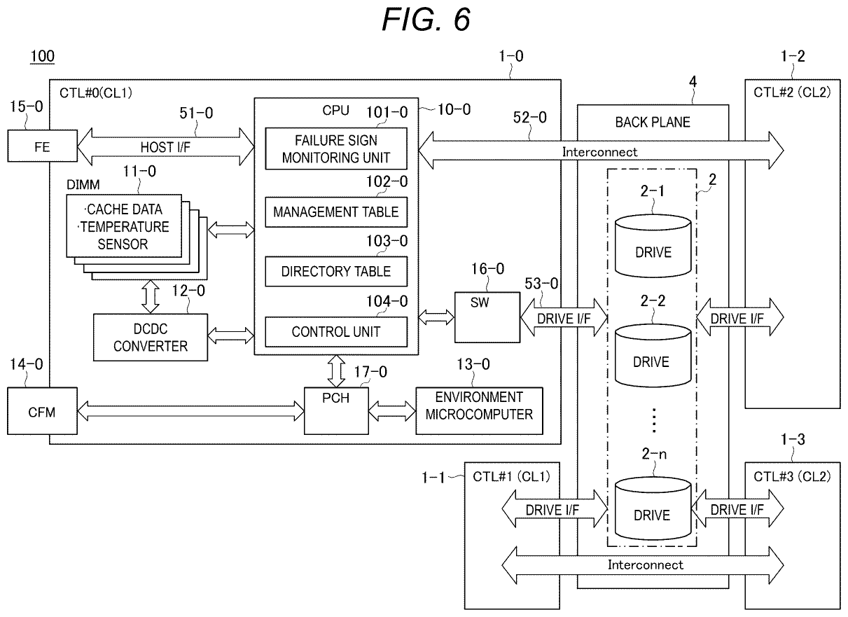

Next, a configuration of a storage system according to an embodiment of the invention will be described with reference to FIG. 6. FIG. 6 is a block diagram showing a configuration example of a storage system 100 according to the present embodiment.

As shown in FIG. 6, the storage system 100 includes four controllers (controller boards) of a controller 1-0 to a controller 1-3. A configuration in the controller is shown only for the controller 1-0. In the storage system 100, the controller 1-0 and the controller 1-1 implement the cluster CL1, and the controller 1-2 and the controller 1-3 implement the cluster CL2. In the following explanation, when there is no need to distinguish between the controller 1-0 to controller 1-3, the controller 1-0 to controller 1-3 are collectively referred to as a “controller 1”. When there is no need to distinguish between the cluster CL1 and the cluster CL2, the cluster CL1 and the cluster CL2 are collectively referred to as a “cluster CL” (an example of a “first cluster” and a “second cluster”).

A configuration of the controller 1 will be described with reference to the controller 1-0. The controller 1-0 includes a CPU 10-0, a DIMM 11-0, a DCDC converter 12-0, an environment MCU 13-0, a cache flash memory (CFM) 14-0, a switch 16-0 (expressed as “SW” in the drawing), and a platform controller hub (PCH) 17-0.

The CPU 10-0 is connected to a front end 15-0 (expressed as “FE” in the drawing) via a host interface (I/F) 51-0. The front end 15-0 is connected to a host (not shown) via a communication network (not shown). The CPU 10-0 is connected to a CPU (not shown) of the controller 1-2 in the cluster CL2 via an intercommunication network 52-0 and is connected to a CPU (not shown) of the controller 1-3 in the cluster CL2 via an intercommunication network (not shown).

The CPU 10-0 is connected to the switch 16-0. The switch 16-0 is connected to a back plane 4 via a drive I/F 53-0. The back plane 4 is a circuit board on which buses for connecting the clusters CL are formed. A drive 2 implemented by a hard disk drive (HDD) or a solid state drive (SSD) is provided on the back plane 4. The drive 2 includes a drive 2-1 to a drive 2-n.

The CPU 10-0 is connected to the PCH 17-0. The PCH 17-0 is connected to the environment MCU 13-0 and the CFM 14-0. The environment MCU 13-0 outputs information on a magnitude of a supply voltage to the DIMM 11-0 to the CPU 10-0 via the PCH 17-0. The CFM 14-0 (an example of a cache data saving memory) is a memory in which cache data stored in the DIMM 11-0 is saved.

The DIMM 11-0 is a memory module having both functions of a main memory and a cache memory. The DIMM 11-0 serving as a cache memory stores the cache data. A temperature sensor is mounted on the DIMM 11-0. The DIMM 11-0 outputs temperature information measured by the temperature sensor to the CPU 10-0.

The DIMM 11-0 stores a program for causing the storage system 100 to execute control processing on the storage system according to the present embodiment. The program is stored in a form of a program code readable by a computer, and the CPU 10-1 sequentially executes operations according to the program code. That is, the DIMM 11-0 is also used as an example of a computer-readable non-transitory recording medium that stores the program to be executed by the computer.

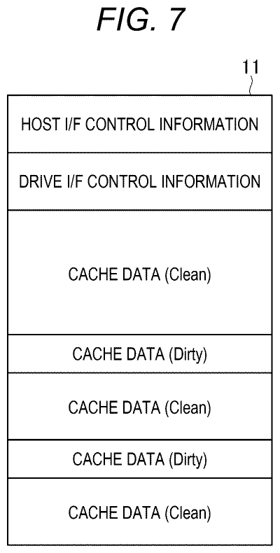

The DCDC converter 12-0 converts a DC voltage supplied from a power source (not shown) into a DC voltage suitable for each of the CPU 10-0 and the DIMM 11-0 and supplies the converted DC voltage to each of the CPU 10-0 and the DIMM 11-0. Examples of various types of information stored in the DIMM 11-0 will be described later with reference to FIG. 7. In the following description, when there is no need to distinguish between the CPU 10-0 to CPU 10-4 (not shown), the CPU 10-0 to CPU 10-4 are collectively referred to as a “CPU 10”. In the following description, when there is no need to distinguish between the DIMM 11-0 to DIMM 11-3 (not shown), the DIMM 11-0 to DIMM 11-3 are collectively referred to as a “DIMM 11”.

The CPU 10-0 includes a failure sign monitoring unit 101-0, a management table 102-0, a directory table 103-0, and a control unit 104-0.

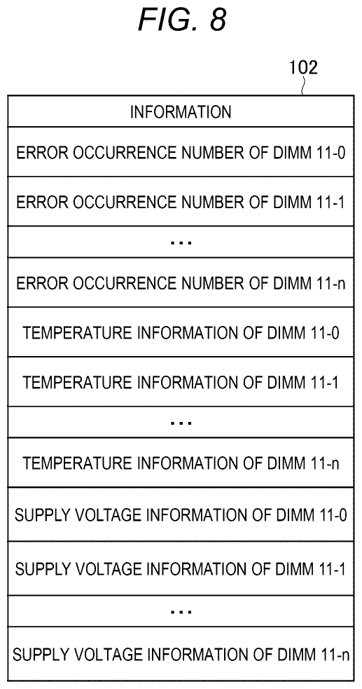

The failure sign monitoring unit 101-1 detects a sign of an unrecoverable failure occurrence that leads to a blockage of the controller 1 based on an occurrence pattern of the correctable error, the temperature information of the DIMM 11-0, information on a supply voltage to the DIMM 11-0, and the like. The number of occurrences of the correctable error, the temperature information, and the information on the supply voltage are stored in the management table 102-0. A configuration of the management table 102-0 (102) will be described later in detail with reference to FIG. 8.

The failure sign monitoring unit 101-0 detects the sign of the failure by, for example, analyzing an occurrence pattern of the correctable error per unit time. Examples of the occurrence pattern of the correctable error include a short-period occurrence pattern or a long-period occurrence pattern and a bit pattern.

The short-period occurrence pattern is, for example, a pattern indicated by the number of occurrences of the correctable error in one second. The long-period occurrence pattern is, for example, a pattern indicated by the number of occurrences of the correctable error in one day. An acquisition period of the occurrence pattern of the correctable error is not limited to these periods. The bit pattern indicates an error occurrence pattern when the correctable error occurs in a plurality of data queues. A state in which the correctable error occurs in a plurality of pieces of data includes a state in which an error occurs simultaneously in the plurality of pieces of data in one element of a memory cell and a state in which an error occurs in each bit in each of two or more elements.

The failure sign monitoring unit 101-0 defines in advance an occurrence pattern of the correctable error of the unrecoverable failure that leads to a blockage of the controller 1, and notifies the control unit 104-0 that the sign of the failure is detected when the acquired occurrence pattern corresponds to the defined occurrence pattern. When the acquired temperature, supply voltage, or the like of the DIMM 11 is a value outside a preset threshold range as a value at the time of normal operation, the failure sign monitoring unit 101-0 detects the sign of the failure.

In a storage system in the related art, an error is analyzed at a timing at which the controller 1 suspected of having a hardware failure is collected from a user. However, in many cases, the error does not reoccur in the repaired controller 1, and in such a case, a cause of the blockage of the controller 1 or the hardware failure cannot be identified. In contrast, the storage system 100 according to the present embodiment acquires the information on the correctable error, and the temperature information and the supply voltage information of the DIMM 11 before the blockage of the controller 1. Therefore, the cause of the blockage of the controller 1 or the hardware failure can be identified based on these pieces of information.

The storage system 100 according to the present embodiment can obtain information such as usage environment or usage tendency of the controller 1 for each user by using the information acquired by the failure sign monitoring unit 101-0. Then, it is possible to take measures to prevent the occurrence of the failure based on the obtained information. For example, when the temperature, the supply voltage, or the like of the DIMM 11 is a cause of the failure, a maintenance person can take preventive measures to prevent these from exceeding the normal range. In addition, the maintenance person can take measures such as replacing the controller 1 having a high probability of failure occurrence with a new controller 1.

The management table 102-0 is a table in which the number of occurrences of correctable error, the temperature information, and the supply voltage information in each DIMM included in the DIMM 11-0 are stored.

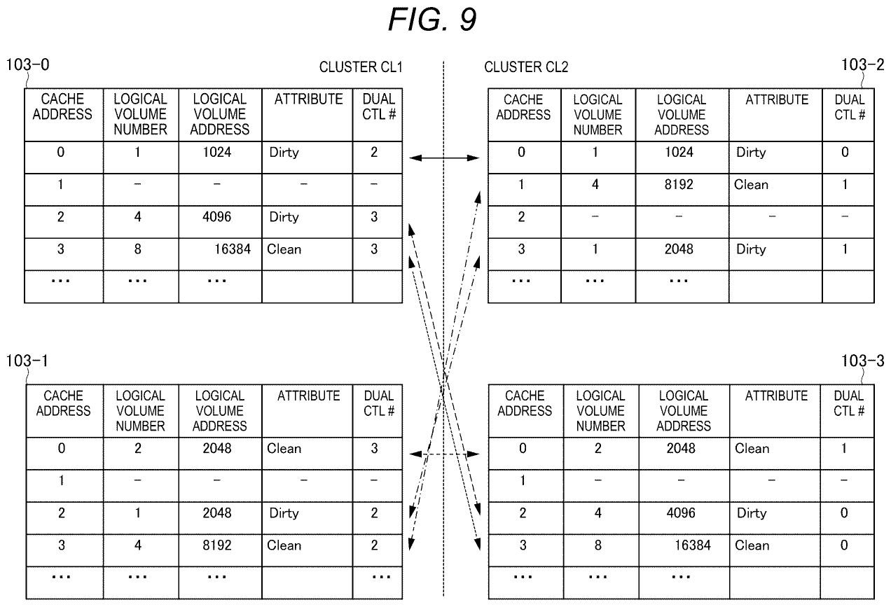

The directory table 103-0 is management information of each area (cache segment) obtained by dividing a cache area of the DIMM 11-0. The directory table 103-0 has entries corresponding to the respective cache segments. Each entry includes a cache address, a logical volume number, a logical volume address, an attribute entry, and the like. A configuration example of the directory table 103-0 will be described later in detail with reference to FIG. 9.

The information stored in the directory table 103-0 can also be referred to and acquired from a CPU in another cluster CL2 such as a CPU in the controller 1-2 in the cluster CL2 connected via the intercommunication network 52-0.

In the following description, when there is no need to distinguish between the failure sign monitoring unit 101-0 to a failure sign monitoring unit 101-3 (not shown), the failure sign monitoring unit 101-0 to the failure sign monitoring unit 101-3 are collectively referred to as a “failure sign monitoring unit 101”. When there is no need to distinguish between the management table 102-0 to a management table 102-3 (not shown), the management table 102-0 to the management table 102-3 are collectively referred to as a “management table 102”. When there is no need to distinguish between the directory table 103-0 to a directory table 103-3 (not shown), the directory table 103-0 to directory table 103-3 are collectively referred to as a “directory table 103”. Further, when there is no need to distinguish between the control unit 104-0 to a control unit 104-3 (not shown), the control unit 104-0 to control unit 104-3 are collectively referred to as a “control unit 104”.

### Storage Information of DIMM

Here, the information stored in the DIMM 11 will be described with reference to FIG. 7. FIG. 7 is a diagram showing an example of storage information of the DIMM 11.

As shown in FIG. 7, information such as host I/F control information, drive I/F control information, cache data (Clean), and cache data (Dirty) are stored in the DIMM 11. “Clean” and “Dirty” of the cache data are information indicating the attribute of the cache data. The cache data whose attribute is “Dirty” (hereinafter also referred to as “dirty data”) is data that is not destaged, that is, data that is not written to the drive 2. The cache data whose attribute is “Clean” (hereinafter referred to as “clean data”) indicates data that is destaged, that is data in which the cache data and the value written to the drive 2 match.

In a state in which the dirty data is present, when the one controller 1 having the redundant configuration is inoperable, the redundancy of the cache data is lost. Further, when the other controller 1 becomes inoperable in this state, the data loss occurs. Therefore, in the present embodiment, the control unit 104 executes data loss avoidance processing when the failure sign monitoring unit 101 detects the sign of the failure.

Returning to FIG. 6, the description will be continued. The control unit 104-0 performs, for example, operations such as the following first redundancy recovery processing to third redundancy recovery processing as the data loss avoidance processing.

First redundancy recovery processing: processing of copying the dirty data to the DIMM 11 (an example of a saving destination) of another controller 1 of another cluster CL.

Second redundancy recovery processing: processing of destaging (moving) the dirty data to the drive 2 (an example of the saving destination) to obtain the clean data.

Third redundancy recovery processing: processing of storing (saving) the dirty data in the CFM 14 (an example of the saving destination) in the own controller 1.

The first redundancy recovery processing is processing capable of reliably achieving recovery of redundancy although it takes a lot of time for execution. The second redundancy recovery processing is processing that requires the shortest time to complete the avoidance processing and also can reliably achieve recovery of redundancy. The third redundancy recovery processing is processing in which if the other controller 1 also becomes inoperable during the execution of the avoidance processing, data loss occurs, and therefore the redundancy may not be recovered. However, in the third redundancy recovery processing, the time until the redundancy recovery processing is completed is the second shortest. The control unit 104 can determine an execution order of the first redundancy recovery processing to the third redundancy recovery processing based on an index indicating which of the velocity until the avoidance processing is completed and the reliability of being able to reliably perform redundancy recovery is more important.

### Configuration of Management Table

Next, a configuration of the management table 102 will be described with reference to FIG. 8. FIG. 8 is a diagram showing a configuration example of the management table 102. In the example shown in FIG. 8, the error occurrence number in each of the DIMM 11-0 to DIMM 11-n, the temperature information of each of the DIMM 11-0 to DIMM 11-n, and the information on a supply voltage to each of the DIMM 11-0 to DIMM 11-n are stored in the management table 102. The error occurrence number is the number of occurrences of the correctable error and is reset at a time point at which one day set in the timer has elapsed or at a time point at which the error occurrence number is equal to or lager than the threshold error number.

### Configuration of Directory Table

Next, a configuration of the directory table 103 will be described with reference to FIG. 9. FIG. 9 is a diagram showing a configuration example of the directory table 103. The left side of FIG. 9 shows the directory table 103-0 of the controller 1-0 implementing the cluster CL1 and the directory table 103-1 of the controller 1-1 implementing the cluster CL1. The right side of FIG. 9 shows the directory table 103-2 of the controller 1-2 implementing the cluster CL2 and the directory table 103-3 of the controller 1-3 implementing the cluster CL2.

Each directory table 103 includes items of “cache address”, “logical volume number”, “logical volume address”, “attribute”, and “dual CTL #”.

In the item of “cache address”, information on the cache address which is an address on a memory of a cache segment to which each entry of the directory table 103 corresponds is stored. In the item of “logical volume number”, information on the number of the logical volume of the cache data stored in the cache segment to which each entry corresponds is stored. In the item of “logical volume address”, information on the address of the logical volume of the data stored in the cache segment to which each entry corresponds is stored.

In the item of “attribute”, information on the attribute of the cache data stored in the cache segment to which each entry corresponds is stored. The attributes of the cache data include “Clean” and “Dirty”. “-” in the item of “attribute” indicates that there is no cache data stored in the cache segment.

In the item of “dual CTL #” of the directory table 103, identification information of the target controller 1 which is a target of duplication (redundant) is stored. Therefore, based on the information described in the directory table 103, the CPU 10 of each controller 1 can grasp information on a storage destination of the duplicated cache data and information on an attribute of the cache data.

In the example shown in FIG. 9, the cache data stored at the cache address “0” of the controller 1-0 of the cluster CL1 is made redundant (duplicated) with the cache data stored at the cache address “0” of the controller 1-2 of the cluster CL2. In the cache segments at the cache address “0” of the controller 1-0 and the controller 1-2, cache data whose logical volume number is “1”, logical volume address is “1024”, and attribute is “Dirty” is stored.

Similarly, the cache data stored at the cache address “2” of the controller 1-0 of the cluster CL1 is made redundant with the cache data stored at the cache address “2” of the controller 1-3 of the cluster CL2. The cache data stored at the cache address “3” of the controller 1-0 of the cluster CL1 is made redundant with the cache data stored at the cache address “3” of the controller 1-3 of the cluster CL2.

### Method for Controlling Storage System

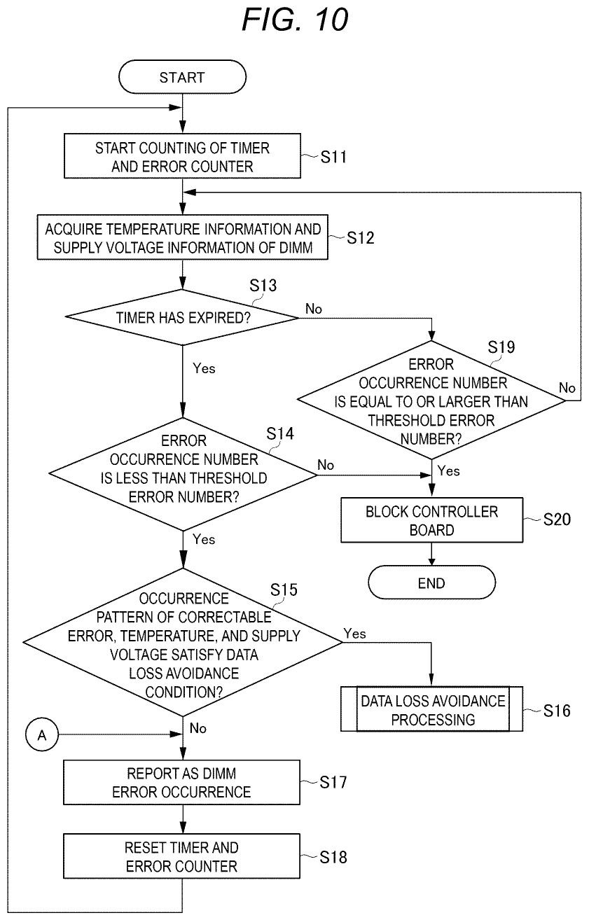

Next, a method for controlling the storage system 100 according to the present embodiment will be described with reference to FIG. 10. FIG. 10 is a flowchart showing an example of a procedure of control processing of the storage system 100.

First, the failure sign monitoring unit 101 of the CPU 10 of the controller 1 starts counting the timer and the error counter (step S11). The processing of step S11 is executed at a preset timing as a start timing of the failure sign monitoring of the DIMM 11. After the counting is started in step S11, the timer is reset, for example, after one day elapses.

Next, the failure sign monitoring unit 101 acquires the temperature information and the supply voltage information of the DIMM 11 (step S12). The processing of step S12 is executed periodically during the monitoring by the failure sign monitoring unit 101.

Next, the failure sign monitoring unit 101 determines whether the timer has expired (step S13). If it is determined in step S13 that the timer has expired (YES in step S13), the failure sign monitoring unit 101 determines whether the error occurrence number is less than the threshold error number (step S14). If it is determined in step S14 that the error occurrence number is less than the threshold error number (YES in step S14), the failure sign monitoring unit 101 determines whether the occurrence pattern of the correctable error, the temperature of the DIMM 11, and the supply voltage to the DIMM 11 satisfy a data loss avoidance condition (step S15).

The data loss avoidance condition is a condition under which it is necessary to execute the data loss avoidance processing. The data loss avoidance condition related to the correctable error of the DIMM 11 is defined by the short-period occurrence pattern or the long-period occurrence pattern and the bit pattern. The data loss avoidance condition related to the temperature and the supply voltage of the DIMM 11 is defined by a threshold range defined by a value at the time of normal operation. When the temperature and the supply voltage of the DIMM 11 acquired by the failure sign monitoring unit 101 are outside the threshold range, the data loss avoidance condition is satisfied.

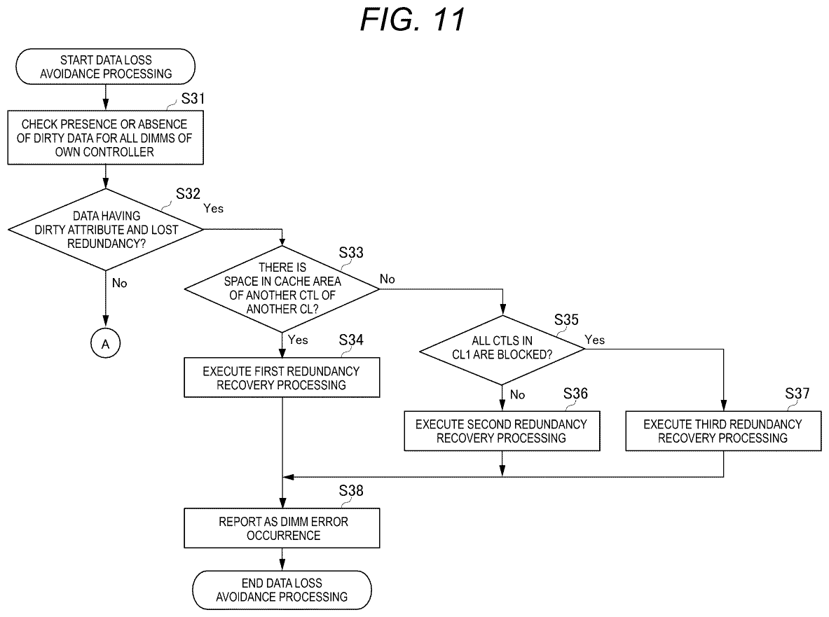

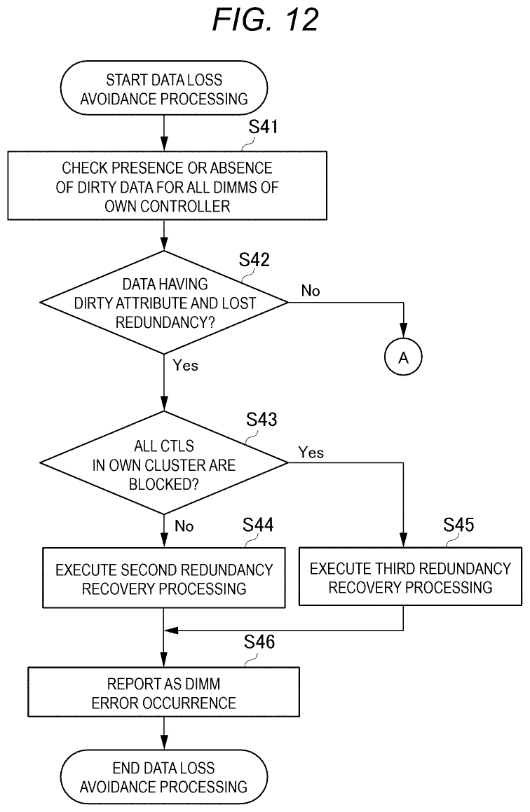

If it is determined in step S15 that the data loss avoidance condition is satisfied (YES in step S15), the control unit 104 executes the data loss avoidance processing (step S16). The data loss avoidance processing will be described in detail with reference to FIGS. 11 and 12 to be described later.

On the other hand, if it is determined in step S15 that the data loss avoidance condition is not satisfied (NO in step S15), the failure sign monitoring unit 101 reports error information to the control unit 104 (step S17). Next, the failure sign monitoring unit 101 resets the timer and the error counter (step S18). After the processing of step S18, the processing returns to step S11.

If it is determined in step S13 that the timer has not expired (NO in step S13), the failure sign monitoring unit 101 determines whether the error occurrence number is equal to or larger than the threshold error number (step S19). If it is determined in step S19 that the error occurrence number is less than the threshold error number (NO in step S19), the processing returns to step S12 and is executed.

On the other hand, if it is determined in step S19 that the error occurrence number is equal to or larger than the threshold error number (YES in step S19), or if the determination in step S14 is NO, the control unit 104 blocks the controller 1 (step S20). After the processing of step S20, the control processing according to the storage system 100 ends.

Next, the data loss avoidance processing executed in step S16 of FIG. 10 will be described with reference to FIGS. 11 and 12. FIG. 11 is a flowchart showing an example of a procedure of the data loss avoidance processing when the speed (velocity) of data loss avoidance is emphasized. FIG. 12 is a flowchart showing an example of the procedure of the data loss avoidance processing when reliability (certainty) of the data loss avoidance is emphasized. Which of the speed emphasized processing shown in FIG. 11 and the reliability emphasized processing shown in FIG. 12 is executed as the data loss avoidance processing is set in advance by a user.

### Data Loss Avoidance Processing (Speed Emphasized)

First, the data loss avoidance processing when the speed of data loss avoidance is emphasized will be described with reference to FIG. 11.

First, the failure sign monitoring unit 101 of the CPU 10 of the controller 1 checks the presence or absence of dirty data for all the DIMM 11 in the own controller (step S31). Next, the failure sign monitoring unit 101 checks whether the cache data to be checked is data having a dirty attribute and lost redundancy (step S32). The data in which redundancy is lost is cache data in which duplication is lost because the other controller 1 having a redundant configuration is blocked.

If it is determined in step S32 that the cache data to be checked is not the data having a dirty attribute and lost redundancy (NO in step S32), the processing of step S17 in FIG. 10 is executed. That is, the information on the detected error is reported to the control unit 104 by the failure sign monitoring unit 101.

On the other hand, if it is determined in step S32 that the cache data to be checked is the data having a dirty attribute and lost redundancy (YES in step S32), the failure sign monitoring unit 101 determines whether there is a space in the cache area in the DIMM 11 of another controller 1 of another cluster CL (step S33). In FIGS. 11 and 12, the cluster CL is expressed as “CL”, and the controller 1 is expressed as “CTL”.

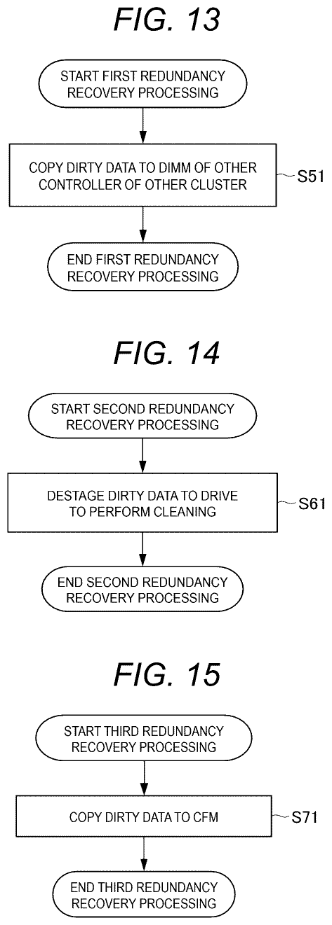

If it is determined in step S33 that there is a space in the cache area (YES in step S33), the control unit 104 executes the first redundancy recovery processing (step S34). The first redundancy recovery processing will be described in detail later with reference to FIG. 13.

On the other hand, if it is determined in step S33 that there is no space in the cache area (NO in step S33), the failure sign monitoring unit 101 determines whether all the controllers 1 of the cluster CL to which the own controller 1 belongs are blocked (step S35). If it is determined in step S35 that not all the controllers 1 are closed, that is, if there is the controller 1 in operation (NO in step S35), the control unit 104 executes the second redundancy recovery processing (step S36). The second redundancy recovery processing will be described in detail later with reference to FIG. 14.

On the other hand, if it is determined in step S35 that all the controllers 1 are blocked (YES in step S35), the control unit 104 executes the third redundancy recovery processing (step S37). The third redundancy recovery processing will be described in detail later with reference to FIG. 15. After the first redundancy recovery processing is executed in step S34, after the second redundancy recovery processing is executed in step S36, or after the third redundancy recovery processing is executed in step S37, the failure sign monitoring unit 101 reports the information on the error to the control unit 104 (step S38). That is, the information on the detected error is reported to the control unit 104 by the failure sign monitoring unit 101. After the information on the error is reported in step S38, the data loss avoidance processing by the storage system 100 ends.

### Data Loss Avoidance Processing (Reliability Emphasized)

Next, the data loss avoidance processing when the reliability of redundancy recovery is emphasized will be described with reference to FIG. 12.

First, the failure sign monitoring unit 101 of the CPU 10 of the controller 1 checks the presence or absence of dirty data for all the DIMM 11 in the own controller (step S41). Next, the failure sign monitoring unit 101 checks whether the cache data to be checked is data having a dirty attribute and lost redundancy (step S42).

If it is determined in step S42 that the cache data to be checked is not the data having a dirty attribute and lost redundancy (NO in step S42), the processing of step S17 in FIG. 10 is executed.

On the other hand, if it is determined in step S42 that the cache data to be checked is the data having the dirty attribute and lost redundancy (YES in step S42), the failure sign monitoring unit 101 determines whether all the controllers 1 of the cluster CL to which the own controller 1 belongs are blocked (step S43). If it is determined in step S43 that not all the controllers 1 are closed, that is, if there is the controller 1 in operation (NO in step S43), the control unit 104 executes the second redundancy recovery processing (step S44).

On the other hand, if it is determined in step S43 that all the controllers 1 are blocked (YES in step S43), the control unit 104 executes the third redundancy recovery processing (step S45). After the second redundancy recovery processing is executed in step S44, or after the third redundancy recovery processing is executed in step S45, the failure sign monitoring unit 101 reports the information on the error to the control unit 104 (step S46). That is, the information on the detected error is reported to the control unit 104 by the failure sign monitoring unit 101. After the information on the error is reported in step S46, the data loss avoidance processing by the storage system 100 ends.

### First Redundancy Recovery Processing

Next, the first redundancy recovery processing will be described with reference to FIG. 13. FIG. 13 is a flowchart showing an example of a procedure of the first redundancy recovery processing. In the first redundancy recovery processing, the control unit 104 moves the dirty data in which redundancy is lost to the DIMM 11 of the controller 1 of the other cluster CL (step S51). After the processing of step S51, the first redundancy recovery processing by the control unit 104 ends. The first redundancy recovery processing is processing executed with the highest priority in the data loss avoidance processing when the speed is emphasized, and the velocity for recovery of redundancy is larger than those of the other two pieces of redundancy recovery processing. As long as the controller 1 of the saving destination of the cache data is not blocked during the execution of the redundancy recovery processing, the redundancy of the cache data is recovered by executing the first redundancy recovery processing.

### Second Redundancy Recovery Processing

Next, the second redundancy recovery processing will be described with reference to FIG. 14. FIG. 14 is a flowchart showing an example of a procedure of the second redundancy recovery processing. In the second redundancy recovery processing, the control unit 104 destages the dirty date in which redundancy is lost to the drive 2 (step S61). After the processing of step S61, the second redundancy recovery processing by the control unit 104 ends. The second redundancy recovery processing is recovery processing executed with the highest priority in the data loss avoidance processing when reliability is emphasized, and is recovery processing executed second in the data loss avoidance processing when the speed is emphasized. The second redundancy recovery processing in which the cache data is destaged to the drive 2 takes longer to execute than the other two pieces of redundancy recovery processing, but can reliably recover the redundancy of the cache data.

### Third Redundancy Recovery Processing

Next, the third redundancy recovery processing will be described with reference to FIG. 15. FIG. 15 is a flowchart showing an example of a procedure of the third redundancy recovery processing. In the third redundancy recovery processing, the control unit 104 copies the dirty data in which redundancy is lost to the CFM 14 (see FIG. 1) of the own controller 1 (step S71). After the processing of step S71, the third redundancy recovery processing by the control unit 104 ends. The third redundancy recovery processing is recovery processing executed third in the data loss avoidance processing when the speed is emphasized. When the third redundancy recovery processing is executed, if both the own controller 1 and the other controller 1 having a redundant configuration are blocked thereafter, that is, if a system down occurs, the redundancy cannot be recovered. However, if the system down does not occur, the redundancy can be recovered using the cache data copied to the CFM 14. In each of the cases in which the speed is emphasized and in which the reliability of redundancy recovery is emphasized, the first redundancy recovery processing to the third redundancy recovery processing may be performed in an order other than the order described above.

The controller 1 of the storage system 100 according to the embodiment described above includes the failure sign monitoring unit 101 configured to acquire information on a state of the DIMM 11, and monitor and detect a sign of an irreparable failure in the DIMM 11 based on the acquired information, and the control unit 104 configured to copy or destage cache data in which redundancy is lost to a specified saving destination when the failure sign monitoring unit 101 detects the sign of the failure. Therefore, according to the present embodiment, since the cache data can be saved in the saving destination before a situation occurs such as the plurality of controllers 1 in the same cluster are blocked continuously, the data loss can be prevented from occurring.

In the embodiment described above, even when the number of occurrences of the correctable error of the DIMM 11 does not exceed the threshold error number, the failure sign monitoring unit 101 acquires the information on the correctable error and the temperature information and the supply voltage information of the DIMM 11. Therefore, even when the error does not reoccur when the controller 1 is inspected after being collected from the user, it is possible to identify the cause of the controller 1 being blocked based on the information collected by the failure sign monitoring unit 101. In addition, based on the information collected by the failure sign monitoring unit 101, it is possible to adjust or repair a portion causing abnormality of the temperature and the supply voltage of the DIMM 11, and take prevention measures such as replacement of the controller 1.

In the embodiment described above, an example is given in which the memory module is implemented by a DIMM, but the invention is not limited thereto. The memory module may be implemented by a device other than the DIMM, or may be implemented by a non-volatile memory.

In the embodiment described above, the configurations of the system are specifically described in detail to describe the invention in an easy-to-understand manner, and the invention is not necessarily limited to including all the described configurations.

In FIG. 6, control lines or information lines indicated by solid lines or arrows are considered to be necessary for the description, and not all control lines and information lines are necessarily shown in a product. Actually, almost all configurations may be considered to be connected.

In the present specification, the processing steps describing time-series processing include not only processing performed in time series according to the described order but also processing not necessarily performed in time series but performed in parallel or individually (for example, parallel processing or processing by an object).

What is claimed is:

1. A storage system comprising:
a plurality of controllers each including a cache memory and having a redundant configuration; and
a drive configured to allow cache data of the cache memory to be stored therein, wherein
the controller includes
a failure sign monitoring unit configured to acquire information on a state of the cache memory, and monitor and detect a sign of an irreparable failure in the cache memory based on the acquired information, and
a control unit configured to copy or move the cache data in which redundancy is lost to a predetermined saving destination when the failure sign monitoring unit detects the sign of the failure.

2. The storage system according to claim 1, wherein
the cache data in which the redundancy is lost is the cache data that is not duplicated because another controller having a redundant configuration with respect to the controller is in an inoperable state.

3. The storage system according to claim 2, wherein
the failure sign monitoring unit acquires information on an occurrence pattern of a correctable error in the cache memory as the information on the state of the cache memory, and detects the sign of the failure when the occurrence pattern satisfies a condition defined in advance.

4. The storage system according to claim 3, wherein
the occurrence pattern is a pattern indicated by the number of occurrences of the correctable error per unit time or a bit pattern of the correctable error.

5. The storage system according to claim 3, wherein
the failure sign monitoring unit acquires information on a temperature of the cache memory as the information on the state of the cache memory, and detects the sign of the failure when the temperature exceeds a predetermined threshold range.

6. The storage system according to claim 3, wherein
the failure sign monitoring unit acquires information on a supply voltage to the cache memory as the information on the state of the cache memory, and detects the sign of the failure when the supply voltage exceeds a predetermined threshold range.

7. The storage system according to claim 5, wherein
the predetermined saving destination of the cache data in which the redundancy is lost is a cache data saving memory in an own controller, the cache memory of another controller in a second cluster having a redundant configuration with respect to a first cluster including the own controller and another controller having a redundant configuration with respect to the own controller, or the drive.

8. The storage system according to claim 7, wherein
when a velocity of recovery of the redundancy of the cache data is emphasized, the control unit preferentially selects first redundancy recovery processing that is processing of copying the cache data in which the redundancy is lost to the cache memory of the other controller of the second cluster.

9. The storage system according to claim 7, wherein
when certainty of the redundancy of the cache data is emphasized, the control unit preferentially selects second redundancy recovery processing that is processing of moving the cache data in which the redundancy is lost to the drive.

10. A method for controlling a storage system including a plurality of controllers each including a cache memory and having a redundant configuration, and a drive configured to allow cache data of the cache memory to be stored therein,
the method comprising:
by the controller,
a procedure of acquiring information on a state of the cache memory, and monitoring and detecting a sign of an irreparable failure in the cache memory based on the acquired information; and
a procedure of copying or moving the cache data in which redundancy is lost to a predetermined saving destination when detecting the sign of the failure.
